(19) United States
(12) Patent Application Publication
(10) Pub. No.: US 2020/0141475 A1
(43) Pub. Date: May 7, 2020

(54) BALL SCREW DEVICE

(71) Applicant: JTEKT CORPORATION, Osaka (JP)

(72) Inventor: Gento ARAMOTO, Osaka-shi (JP)

(73) Assignee: JTEKT CORPORATION, Osaka (JP)

(21) Appl. No.: 16/597,019

(22) Filed: Oct. 9, 2019

(30) Foreign Application Priority Data
Nov. 5, 2018 (JP) 2018-208422
Mar. 29, 2019 (JP) 2019-067435

(51) Int. Cl. F16H 25/22

(52) U.S. Cl. CPC F16H 25/2238; F16D 2125/40

(57) ABSTRACT

A ball screw device includes a screw shaft having a first helical groove provided on an outer periphery of the screw shaft; a nut having a second helical groove provided on an inner periphery of the nut, the nut being fitted on the outer periphery of the screw shaft; a plurality of balls that are disposed in a ball groove such that the plurality of balls are rollable, the ball groove being provided between the first helical groove and the second helical groove that are disposed so as to face each other in a radial direction; a helical member that extends in a helical shape along the ball groove and is displaceable along the ball groove; and a first biasing member that biases the helical member toward the plurality of balls.

### INCORPORATION BY REFERENCE

The disclosure of Japanese Patent Application No. 2019-067435 filed on Mar. 29, 2019 including the specification, drawings and abstract is incorporated herein by reference in its entirety.

### BACKGROUND

### 1. Technical Field

The disclosure relates to a ball screw device.

### 2. Description of Related Art

Ball screw devices can convert a rotary motion to a linear motion and are widely used in various fields. For example, Japanese Unexamined Patent Application Publication (Translation of PCT Application) No. 2010-505072 (JP 2010-505072 A) discloses a ball screw device 81 as shown in FIG. 11. The ball screw device 81 is what is called a non-recirculating ball screw device in which balls 89 do not recirculate but reciprocate within a predetermined range. The ball screw device 81 is used in brake devices of vehicles (not shown) etc. The brake device is a device that operates the ball screw device 81 by a built-in motor to apply a braking force to a wheel. When the brake device is operated, a screw shaft 83 is rotated and the balls 89 move along a ball groove 87. When the brake device is released, the screw shaft 83 is rotated in the opposite direction and the balls 89 return approximately to their original positions (initial positions).

However, the initial positions of the balls 89 may be displaced to positions near a terminal end of the ball groove 87 during repeated use of the brake device. When the brake device is operated in this state, the balls 89 quickly reach the terminal end of the ball groove 87 and cannot roll anymore. The screw shaft 83 is therefore not smoothly rotated, which may degrade performance such as response of the brake device. Thus, the ball screw device 81 of JP 2010-505072 A has coil springs 90 respectively provided on both sides of the ball row in order to return the balls 89 to their initial positions when operation of the ball screw device 81 is finished.

### SUMMARY

It is desired to increase the movable range in which a nut 85 is movable, in order to extend the range in which the non-recirculating ball screw device can be applied.

However, in the ball screw device 81 of JP 2010-505072 A, when the rotation angle of the screw shaft 83 is increased, the movement amount of the balls 89 is increased accordingly. The coils (windings, i.e., turns of a wire) of the coil spring 90 are therefore brought into close contact with each other, and the screw shaft 83 cannot be smoothly rotated. One possible way to increase the movable range of the nut 85 is to increase the overall length of the coil spring 90 to increase the allowable deflection of the coil spring 90, namely the amount by which the coil spring 90 can be deflected until the coils of the coil spring 90 closely contact each other. However, when the overall length of the coil spring 90 is increased, the outer periphery of the coil spring 90 is rubbed hard against the inner periphery of the ball groove 87, and the coil spring 90 cannot be smoothly compressed. This makes it difficult for the nut 85 to move smoothly and may lead to breakage of the coil spring 90. The allowable deflection is thus substantially limited. As described above, in the non-recirculating ball screw device, it is difficult to increase the range in which the nut 85 can move smoothly in the axial direction.

The disclosure provides a ball screw device in which a nut is movable in an increased range in a axial direction, and a ball row is returned to its initial position when operation of the ball screw device is finished, so that the nut can be moved smoothly in a large range in the axial direction.

A ball screw device according to an aspect of the disclosure includes a screw shaft having a first helical groove provided on an outer periphery of the screw shaft; a nut having a second helical groove provided on an inner periphery of the nut, the nut being fitted on the outer periphery of the screw shaft; a plurality of balls that are disposed in a ball groove such that the plurality of balls are rollable, the ball groove being provided between the first helical groove and the second helical groove that are disposed so as to face each other in a radial direction; a helical member that extends in a helical shape along the ball groove and is displaceable along the ball groove; and a first biasing member that biases the helical member toward the plurality of balls.

According to the above aspect of the disclosure, it is possible to provide the ball screw device in which a nut is movable in an increased range in the axial direction, and a ball row is returned to its initial position when operation of the ball screw device is finished, so that the nut can be moved smoothly in a large range in the axial direction.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view showing an example of a brake device using a ball screw device of a first embodiment;

FIG. 2 is a sectional view in an axial direction showing the ball screw device of the first embodiment;

FIG. 3 is a sectional view in the axial direction showing the ball screw device of FIG. 2 with its screw shaft removed;

FIG. 4 is a schematic view showing the form of a stopper portion formed in a nut;

FIGS. 5A and 5B show the shape of a coupling member, where FIG. 5A is a front view as viewed in the axial direction, and FIG. 5B is a sectional view taken along line X-X in FIG. 5A and viewed in the direction of arrows in FIG. 5A;

FIG. 6 shows the positions of a helical member etc. under no load condition in an upper portion (a), and shows the positions of the helical member etc. at the time when the nut is pushed toward a first axial side in a lower portion (b);

FIG. 7 is a sectional view showing an example of a brake device using a ball screw device of a second embodiment;

FIG. 8 is a sectional view in the axial direction showing the ball screw device of the second embodiment;

FIGS. 9A and 9B are schematic views showing the form of a spring end fixing member and a coupling member of the second embodiment;

FIG. 10 is similar to FIG. 6, and shows operation of the ball screw device of the second embodiment; and

FIG. 11 is a perspective view showing a partial section of a ball screw device in related art.

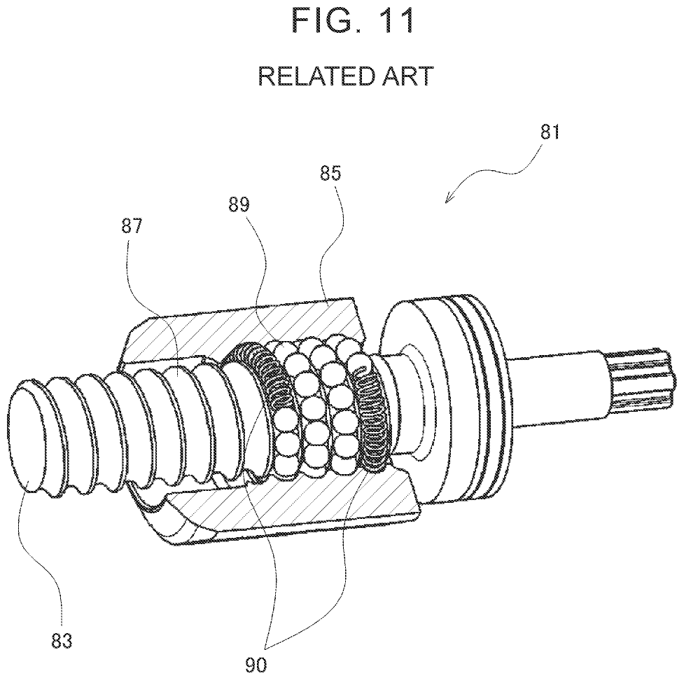

### DETAILED DESCRIPTION OF EMBODIMENTS

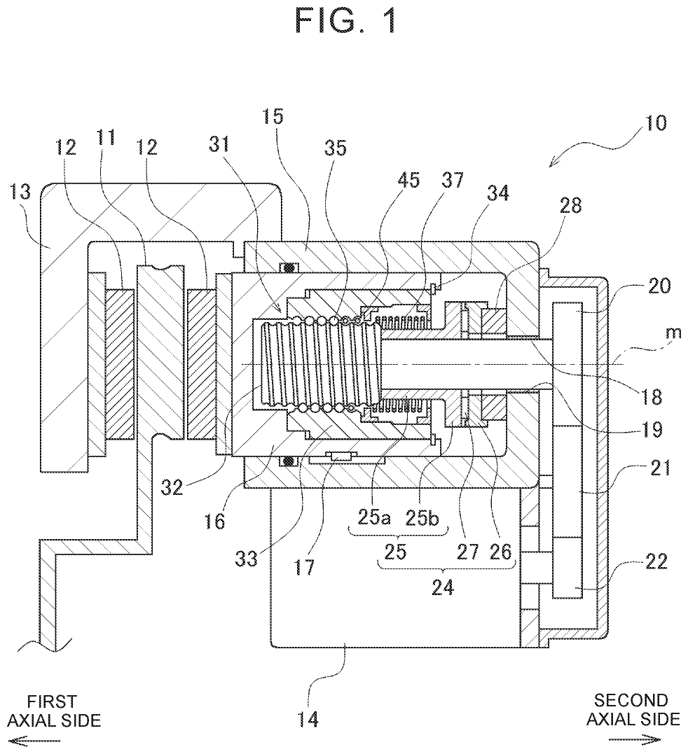

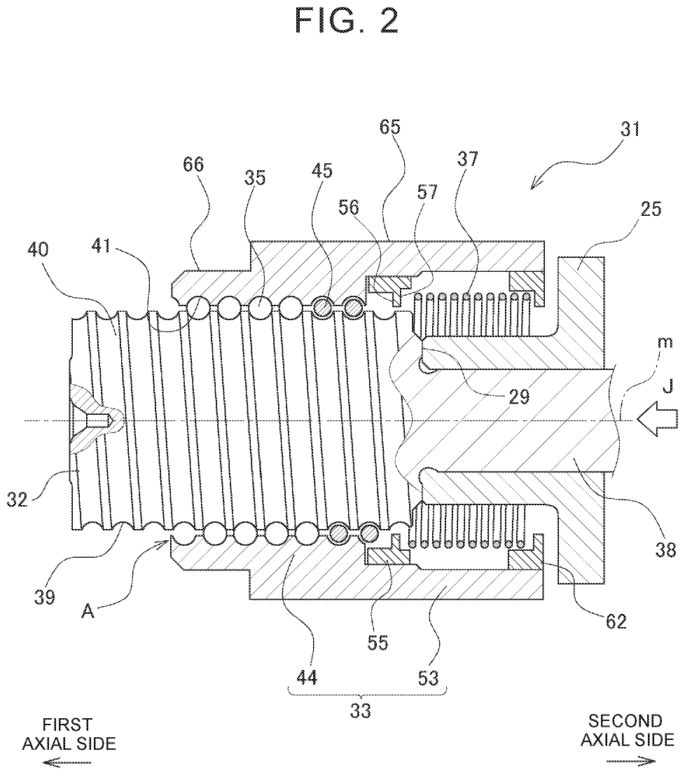

An embodiment (hereinafter referred to as the first embodiment) of the disclosure will be described in detail with reference to the accompanying drawings. A ball screw device 31 of the first embodiment is used in a brake device 10 of a vehicle (for example, an automobile). FIG. 1 is a sectional view in an axial direction showing a schematic structure of the brake device 10. FIG. 2 is a sectional view in the axial direction showing the ball screw device 31. The brake device 10 is a device that presses brake pads 12 against a brake rotor 11 rotating with a wheel (not shown) of the vehicle to apply a braking force by friction. In the following description, the axial direction refers to the direction of the central axis m of a screw shaft 32 of the ball screw device 31, the radial direction refers to the direction perpendicular to the direction of the central axis m, and the circumferential direction refers to the direction extending about the central axis m. The left side (one side in the axial direction) in FIGS. 1 and 2 may be referred to as the first axial side, and the right side (the other side in the axial direction) in FIGS. 1 and 2 may be referred to as the second axial side.

The brake device 10 includes a caliper 13, the pair of brake pads 12 with the brake rotor 11 interposed therebetween, the ball screw device 31 that biases (urges) the brake pads 12 toward the brake rotor 11, and a motor 14 that operates the ball screw device 31.

The caliper 13 is in the shape of a saddle and is disposed so as to cover a part of the outer periphery of the brake rotor 11. The caliper 13 is supported in a floating state by a knuckle, not shown, etc. such that the caliper 13 can move in the axial direction and is fixed in the circumferential direction. A cylinder 15 in the shape of a bottomed cylinder is formed integrally with the caliper 13. The cylinder 15 has a cylindrical inner peripheral surface and is open toward the brake rotor 11. The cylinder 15 has a hole 19 in its bottom. The hole 19 extends through the bottom of the cylinder 15 in the axial direction and is coaxial with the central axis m. A plain bearing (sliding bearing) 18 made of a sintered metal, a resin material, or the like is fitted in the hole 19. A piston 16 is inserted in the cylinder 15. The piston 16 has a cylindrical outer peripheral surface and is fitted in the cylinder 15 with a small clearance between the piston 16 and the inner periphery of the cylinder 15, and the piston 16 can be displaced in the axial direction toward the brake rotor 11. A sliding key 17 is provided on the fitting surface of the piston 16, which is fitted to the cylinder 15. The piston 16 can reciprocate in the axial direction with respect to the cylinder 15 but cannot rotate in the circumferential direction.

The ball screw device 31 is mounted in the piston 16. The ball screw device 31 includes the screw shaft 32, a nut 33, and a plurality of balls 35 and can convert a rotary motion of the screw shaft 32 to an axial motion of the nut 33.

As shown in FIG. 2, the nut 33 has a stepped, substantially cylindrical shape having an inside diameter and an outside diameter that vary in the axial direction. The nut 33 has an outer peripheral surface 65 provided on its second axial side and an outer peripheral surface 66 provided on its first axial side. The outer peripheral surface 65 is a cylindrical surface coaxial with the central axis m and the outer peripheral surface 66 is a polygonal surface in a section taken along a direction perpendicular to the central axis m. As shown in FIG. 1, the nut 33 is fitted in the inner periphery of the piston 16. The inner periphery of the piston 16 has a shape similar to that of the outer periphery of the nut 33. Namely, a part of the inner peripheral surface of the piston 16 in the axial direction has a polygonal surface. The polygonal outer peripheral surface 66 of the nut 33 is fitted to the polygonal inner peripheral surface of the piston 16. The piston 16 and the nut 33 are thus combined such that the piston 16 and the nut 33 cannot rotate relative to each other in the circumferential direction. A snap ring 34 is then disposed in the piston 16 to prevent the nut 33 from coming off from the piston 16 in the axial direction.

The screw shaft 32 has a substantially cylindrical inner groove formation portion 40 (see FIG. 2) and a cylindrical shaft portion 38 which are coaxially connected with each other. The inner groove formation portion 40 has a first helical groove 39 formed on the outer periphery thereof. The shaft portion 38 has a smaller diameter than that of the inner groove formation portion 40. The inner groove formation portion 40 and the shaft portion 38 are connected by a step side surface 29 extending in the direction perpendicular to the central axis m. The shaft portion 38 is inserted through the plain bearing 18. There is a small clearance between the inner periphery of the plain bearing 18 and the outer periphery of the shaft portion 38. The screw shaft 32 is guided by the plain bearing 18 so that the screw shaft 32 can rotate coaxially with the central axis m.

A thrust bearing 24 and an axial force measuring device 28 are arranged in series in the axial direction between the step side surface 29 and the bottom of the cylinder 15. The thrust bearing 24 includes a first-side raceway member 25, a second-side raceway member 26, and a plurality of cylindrical rollers 27. The first-side raceway member 25 is a single-piece member including a sleeve portion 25a and a disc-shaped flange portion 25b. The sleeve portion 25a is fitted on the screw shaft 32, and the flange portion 25b extends in the direction perpendicular to the central axis m. The sleeve portion 25a is fitted on the screw shaft 32 by interference fit, and an end of the sleeve portion 25a, which is located on the first axial side, contacts the step side surface 29 in the axial direction. The term “an end of a member, which is located on the first axial side” means an end located closer to the first axial side than the other end of the member is. The term “an end of a member, which is located on the second axial side” means an end located closer to the second axial side than the other end of the member is. The cylindrical rollers 27 are arranged at regular intervals in the circumferential direction and coaxially with the central axis m between the flange portion 25b of the first-side raceway member 25 and the second-side raceway member 26. The second-side raceway member 26 is fixed to the bottom of the cylinder 15 via the axial force measuring device 28. The thrust bearing 24 allows the screw shaft 32 to rotate smoothly while supporting an axial load. The second-side raceway member 26 and the axial force measuring device 28 have an annular shape and are arranged coaxially with the central axis m. The inside diameter of the second-side raceway member 26 and the inside diameter of the axial force measuring device 28 are larger than the outside diameter of the shaft portion 38 of the screw shaft 32.

Accordingly, the screw shaft 32 can rotate about the central axis m and cannot move in the axial direction.

A gear 20 is attached to an end of the screw shaft 32, and a gear 22 is attached to a rotary shaft of the motor 14. The gear 20 meshes with the gear 22 via an intermediate gear 21. The motor 14 is disposed outside the cylinder 15. The motor 14 rotates in the forward or reverse direction or stops in response to a signal from a control device (not shown). As the motor 14 rotates, the ball screw device 31 is operated accordingly.

The brake device 10 has the pair of brake pads 12 facing each other in the axial direction with the brake rotor 11 interposed therebetween. One of the brake pads 12 is disposed on an end of the piston 16, and the other brake pad 12 is disposed on an inner wall of the caliper 13. When the screw shaft 32 rotates with rotation of the motor 14, the piston 16 is pushed toward the first axial side, so that the brake pads 12 move closer to each other. The pair of brake pads 12 supported by the caliper 13 can thus hold the brake rotor 11 therebetween from both sides in the axial direction. A braking force is applied to the wheel by sliding friction between the brake rotor 11 and the brake pads 12. The axial force measuring device 28 can measure the magnitude of the load that is applied to the screw shaft 32 during running of the vehicle. Accordingly, for example, the pressing load of the brake pads 12 can be sequentially controlled by a vehicle control device such as an anti-lock braking system (ABS), and driving stability of the vehicle can be improved.

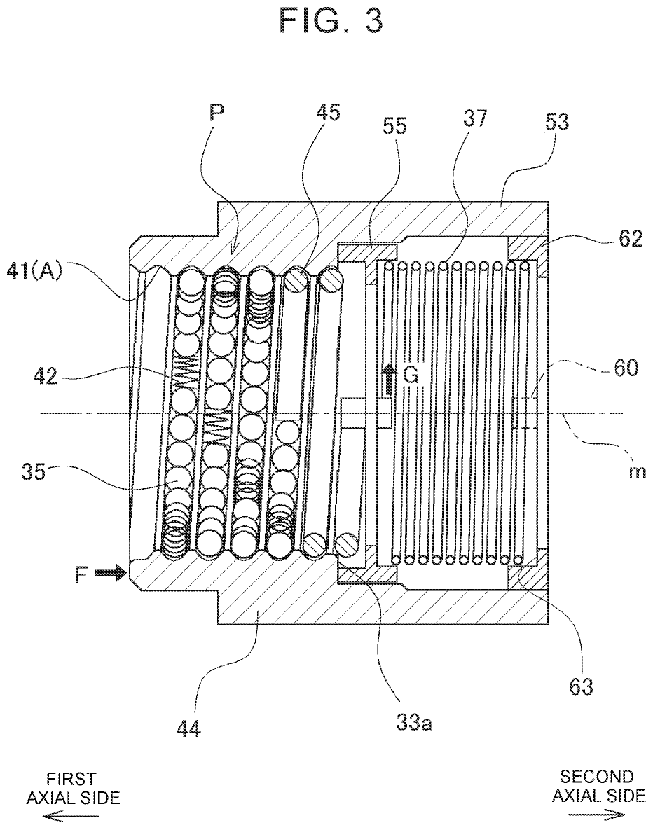

The ball screw device 31 will be described with reference to FIGS. 2 and 3. FIG. 3 is a sectional view in the axial direction showing the ball screw device 31 with the screw shaft 32 removed. As shown in FIG. 2, the ball screw device 31 includes the screw shaft 32, the nut 33, the plurality of balls 35, a helical member 45, and a helical torsion spring 37 (first biasing member).

The screw shaft 32 includes the inner groove formation portion 40 and the shaft portion 38 which are coaxially connected with each other. The inner groove formation portion 40 has the first helical groove 39 provided on the outer periphery thereof. The first helical groove 39 has an arc-shaped axial section (i.e., an arc-shaped section in the axial direction) with a radius of curvature slightly larger than that of the outer periphery of the ball 35. The first helical groove 39 is formed to have a helical shape along the entire length (entire area) of the inner groove formation portion 40 in the axial direction. The first helical groove 39 is a right-handed helical groove. More specifically, the first helical groove 39 is formed to extend clockwise around the inner groove formation portion 40 (i.e., along the outer periphery of the inner groove formation portion 40) while extending toward the first axial side, as viewed in the direction of arrow J in FIG. 2.

The nut 33 has a substantially cylindrical overall shape. The nut 33 has a stepped, substantially cylindrical inner peripheral surface, and the inside diameter of the nut 33 varies in the axial direction. The nut 33 has an outer groove formation portion 44 provided on its first axial side and a spring accommodating portion 53 provided on its second axial side. The outer groove formation portion 44 has a smaller inside diameter, and the spring accommodating portion 53 has a larger inside diameter. A second helical groove 41 is formed to have a helical shape on the inner periphery of the outer groove formation portion 44 along the entire length (entire area) of the outer groove formation portion 44 in the axial direction. The second helical groove 41 has an arc-shaped axial section (i.e., an arc-shaped section in the axial direction) with a radius of curvature slightly larger than that of the outer periphery of the ball 35. The direction of helix of the second helical groove 41 is the same as that of the first helical groove 39. The inner groove formation portion 40 of the screw shaft 32 is longer in the axial direction than the outer groove formation portion 44 of the nut 33, and the first helical groove 39 is therefore formed in a larger range in the axial direction than a range in which the second helical groove 41 is formed. The nut 33 is fitted on (in other words, fitted to) the outer periphery of the screw shaft 32, and the first helical groove 39 and the second helical groove 41 face each other in the radial direction to form a helical ball groove A.

Referring to FIG. 3, the plurality of balls 35 are arranged in a row along the ball groove A. The balls 35 arranged in the ball groove A are in contact with the first helical groove 39 and the second helical groove 41, and thus, the balls 35 can support an axial external force F applied to the nut 33. When the screw shaft 32 rotates, the balls 35 roll in the ball groove A. Accordingly, even when a large axial external force F is being applied to the nut 33, the screw shaft 32 can be smoothly rotated and the nut 33 can be easily moved in the axial direction. In the first embodiment, separating springs 42, which are coil springs with a short free length, are inserted at a plurality of positions in the row of the plurality of balls 35 at predetermined intervals. Even when any of the balls 35 is delayed in moving while rolling in the ball groove A, the separating springs 42 prevent the balls 35 from strongly contacting each other and thus prevent, for example, wear of the balls 35, reduction in transmission efficiency of the ball screw device 31. The plurality of separating springs 42 and the plurality of balls 35 which are arranged in a row along the ball groove A in this manner are referred to as a ball row P.

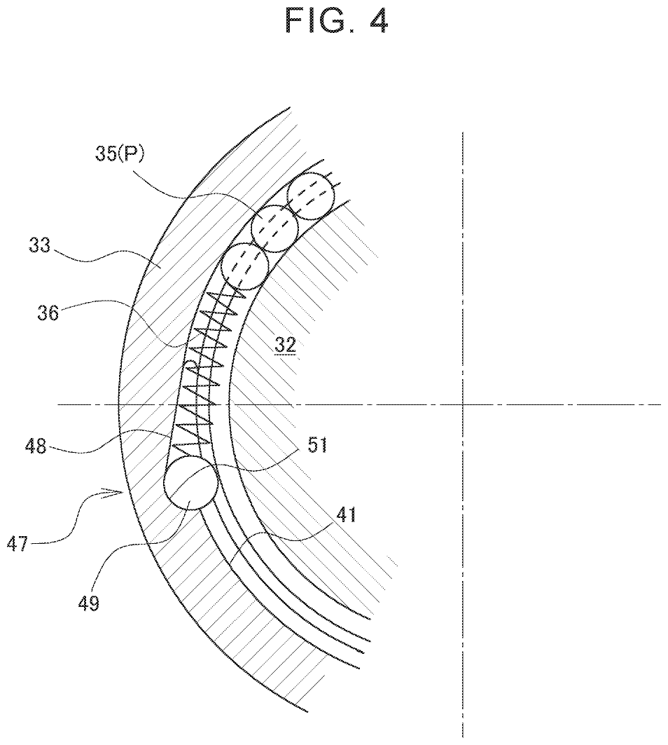

Although not shown in FIGS. 2 and 3, the nut 33 has a stopper portion 47 (see FIG. 4) provided in an end thereof which is located on the first axial side (which is the same as the terminal end of the second helical groove 41, the terminal end being located on the first axial side). FIG. 4 schematically shows the form of the stopper portion 47 when the nut 33 is viewed from the first axial side toward the second axial side. In FIG. 4, a direction toward the lower side of the stopper portion 47 is a direction toward the end of the second helical groove 41, which is located on the first axial side, and a direction toward the upper side of the stopper portion 47 is a direction toward the end of the second helical groove 41, which is located on the second axial side.

The stopper portion 47 includes a recess 48 and a stopper ball 49. The recess 48 is formed on the inner periphery of the nut 33 so as to be recessed radially outward. The radial depth of the recess 48 increases in a direction toward the first axial side along the second helical groove 41 (i.e., in a direction from the upper side toward the lower side in FIG. 4). The stopper ball 49 has a larger diameter than that of each of the balls 35 forming the ball row P. The stopper ball 49 is in contact with a wall surface 51 of the recess 48 so that the stopper ball 49 cannot be displaced toward the first axial side. A first-side coil spring 36 (second biasing member) is disposed between the ball row P and the stopper ball 49 so that the ball row P and the stopper ball 49 do not directly contact each other. The stopper portion 47 prevents the balls 35 and the coil springs 42, 36 from falling off from the ball groove A.

Next, the helical member 45 and the helical torsion spring 37 will be described. The helical member 45 is made of a steel material such as a wire for springs, fiber-reinforced plastic (FRP), or the like, and is formed to have the same helical shape as that of the ball groove A. The same helical shape herein means having the same average coil diameter as viewed in the axial direction and the same helix pitch (which refers to the axial dimension (axial length) between the centers of adjacent coils in an axial section). The helical member 45 is disposed on the second axial side of the ball row P in the ball groove A. The diameter (thickness) of a line (for example, a wire) of the helical member 45 is smaller than the inside diameter of the ball groove A. Since there is a clearance between the outer periphery of the helical member 45 and the inner periphery of the ball groove A, the helical member 45 moves along the ball groove A so as to rotate about the central axis m. The helical member 45 can thus move along the ball groove A.

The helical torsion spring 37 is accommodated in the spring accommodating portion 53. The helical torsion spring 37 is produced by winding a wire for springs such as a piano wire into a helix. The helical torsion spring 37 is right-hand wound such that coils (windings, i.e., turns of a wire) are arranged at predetermined intervals in the axial direction. The helical torsion spring 37 can therefore be elastically compressed in the axial direction. The helical torsion spring 37 has an open end on each of both sides in the axial direction, and there is a space between each terminal end of the helical torsion spring 37 and a coil of the helical torsion spring 37 which is located adjacent to the terminal end. The inside diameter of the helical torsion spring 37 is slightly larger than the outside diameter of the screw shaft 32. Accordingly, the helical torsion spring 37 is fitted over the screw shaft 32 so that there is a small radial clearance between the helical torsion spring 37 and the outer periphery of the screw shaft 32. There is a large radial clearance between the helical torsion spring 37 and the inner periphery of the spring accommodating portion 53.

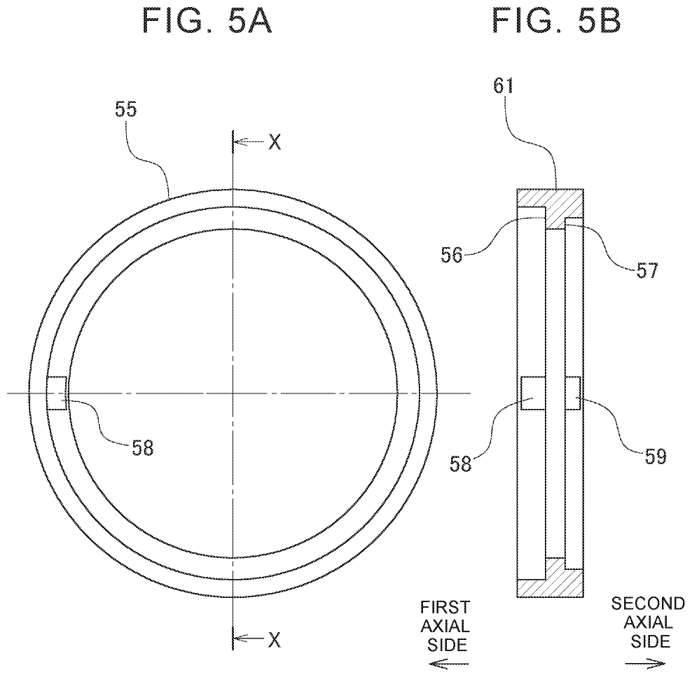

The end (one end, in other words, a first end) of the helical torsion spring 37, which is located on the first axial side, is in contact with the helical member 45 via a coupling member 55. FIGS. 5A and 5B show the shape of the coupling member 55. FIG. 5A is a front view as viewed in the axial direction, and FIG. 5B is a sectional view taken along line X-X in FIG. 5A and viewed in the direction of arrows in FIG. 5A. The coupling member 55 has a substantially disc shape and is made of carbon steel, synthetic resin, or the like. The coupling member 55 has a seating surface 56 on its first axial side and has a first spring seat 57 on its second axial side. The seating surface 56 contacts the helical member 45 in the axial direction, and the first spring seat 57 contacts the helical torsion spring 37 in the axial direction. The seating surface 56 has a protrusion 58 that contacts the terminal end of the helical member 45 in the circumferential direction, the terminal end being located on the second axial side. Similarly, the first spring seat 57 has a protrusion 59 that contacts the terminal end of the helical torsion spring 37, the terminal end being located on the first axial side. The coupling member 55 has a cylindrical outer peripheral surface 61. The coupling member 55 is fitted in the spring accommodating portion 53 with a clearance between the outer peripheral surface 61 of the coupling member 55 and the inner periphery of the spring accommodating portion 53. Accordingly, the coupling member 55 can be displaced in the axial direction and can rotate about the central axis m.

Referring back to FIG. 3, the end (the other end, in other words, a second end) of the helical torsion spring 37, which is located on the second axial side, is locked (stopped) by a spring end fixing member 62. The spring end fixing member 62 has a substantially disc shape and is made of carbon steel, synthetic resin, or the like. The spring end fixing member 62 has a cylindrical outer peripheral surface and is fitted in the end of the spring accommodating portion 53, which is located on the second axial side, by interference fit. The spring end fixing member 62 has a second spring seat 63 facing toward the first axial side. The second spring seat 63 contacts the helical torsion spring 37 in the axial direction. The second spring seat 63 has a protrusion 60 that contacts the terminal end of the helical torsion spring 37 in the circumferential direction, the terminal end being located on the second axial side. The protrusion 60 is in a form similar to that of the protrusion 59 of the first spring seat 57.

Arrangement of the ball row P under no load condition before the ball screw device 31 is operated will be described in detail with reference to FIG. 3. The no load condition herein means that no external force F is applied to the ball screw device 31. Under no load condition, the contact load between each ball 35 and the first and second helical grooves 39, 41 is not large, and the balls 35 can therefore be displaced along the ball groove A.

The first-side coil spring 36 (see FIG. 4) is disposed on the first axial side in the ball groove A, and the ball row P is disposed on the second axial side relative to the first-side coil spring 36 (i.e., the ball row P is disposed closer to the second axial side than the first-side coil spring 36 is). The helical member 45 is disposed on the second axial side relative to the ball row P (i.e., the helical member 45 is disposed closer to the second axial side than the ball row P is). One of the balls 35 of the ball row P, which is located closest to the second axial side, contacts the end of the helical member 45, which is located on the first axial side. The end of the helical member 45, which is located on the second axial side, protrudes beyond an end face 33a of the outer groove formation portion 44 of the nut 33 toward the second axial side, the end face 33a being an end face located on the second axial side. The end of the helical member 45, which is located on the second axial side, is in contact with the seating surface 56 of the coupling member 55 in the axial direction and is in contact with the protrusion 58 in the circumferential direction.

The helical torsion spring 37 is disposed on the second axial side relative to the coupling member 55 (the helical torsion spring 37 is disposed closer to the second axial side than the coupling member 55 is). The end of the helical torsion spring 37, which is located on the first axial side, is in contact with the first spring seat 57 of the coupling member 55 in the axial direction and in contact with the protrusion 59 in the circumferential direction. The end of the helical torsion spring 37, which is located on the second axial side, is in contact with the second spring seat 63 of the spring end fixing member 62 in the axial direction and in contact with the protrusion 60 in the circumferential direction.

The helical torsion spring 37 is disposed such that the position of the end of the helical torsion spring 37, which is located on the first axial side, is elastically displaced slightly in the direction shown by arrow G from the position of the end of the helical torsion spring 37, which is located on the first axial side, in a free state. The helical torsion spring 37 thus has a force that elastically restores itself to the shape in the free state. The helical torsion spring 37 can therefore bias (urges) the helical member 45 clockwise about the central axis m, namely toward the ball row P. At this time, the force of the first-side coil spring 36 biasing the ball row P in the axial direction, the force of the helical torsion spring 37 biasing the ball row P toward the first axial side, and the force of each separating spring 42 biasing the balls 35 respectively provided on both sides of the separating spring 42 along the ball groove A are substantially balanced. Under no load condition, the ball row P and the first-side coil spring 36 are thus located in close contact with each other and closer to the first axial side. The position of the ball row P under no load condition, namely the position of the ball row P when no external force F is applied, is referred to as the initial position of the ball row P.

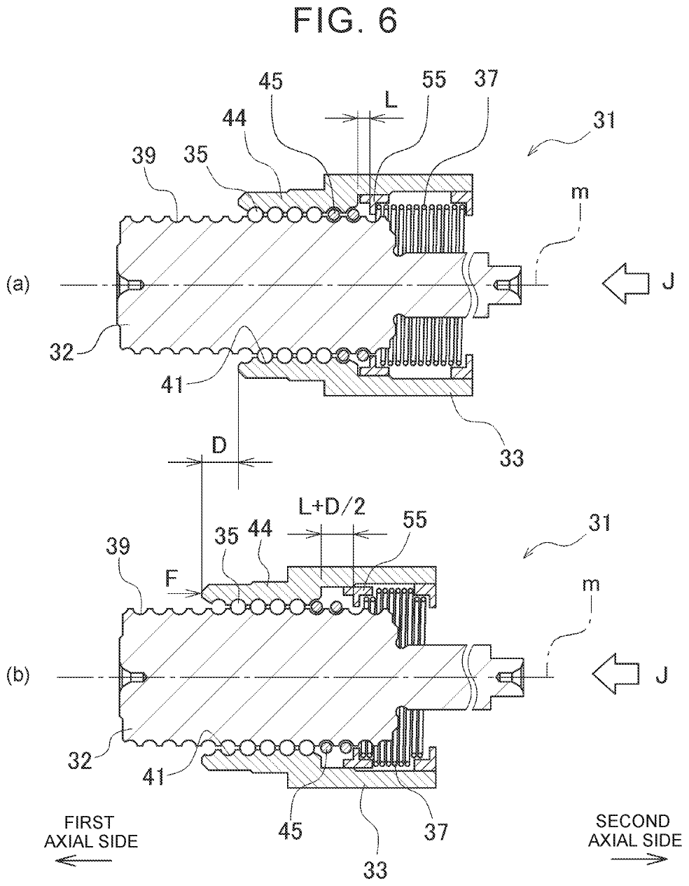

Operation of each part at the time when the ball screw device 31 is operated and functions and effects of the ball screw device 31 will be described with reference to FIG. 6. An upper potion (a) in FIG. 6 shows the positions of the helical member 45, the helical torsion spring 37, etc. with respect to the screw shaft 32 under no load condition before the ball screw device 31 is operated. A lower portion (b) in FIG. 6 shows the positions of the helical member 45, the helical torsion spring 37, etc. with respect to the screw shaft 32 at the time when the screw shaft 32 is rotated and the nut 33 is pushed toward the first axial side. Each of the upper portion (a) and the lower portion (b) of FIG. 6 shows the ball screw device 31 in the same orientation as in FIG. 1. The piston 16, the brake pads 12, etc. are not shown in FIG. 6. In the following description, the direction in which the screw shaft 32 and the ball row P rotate or move about the central axis m is the direction as viewed in the direction of arrow J in FIG. 6.

As shown in the upper portion (a) in FIG. 6, before the ball screw device 31 is operated, the coupling member 55 is located near the outer groove formation portion 44 of the nut 33 in the axial direction.

As shown in the lower portion (b) in FIG. 6, the ball screw device 31 is then operated. As described above, in the first embodiment, the first helical groove 39 is a right-handed helical groove. When the screw shaft 32 is rotated counterclockwise, the nut 33 is displaced toward the first axial side, and the piston 16, not shown, is pushed toward the brake rotor 11. As the brake pads 12 are pressed against the brake rotor 11, the reaction force is applied to the nut 33 in the axial direction as an external force F, and the balls 35 are strongly pressed against the first helical groove 39 and the second helical groove 41. The balls 35 thus roll in the first helical groove 39 and the second helical groove 41 with rotation of the screw shaft 32. Since the screw shaft 32 is rotated counterclockwise, the balls 35 roll counterclockwise and move in the second helical groove 41 toward the second axial side. At this time, the helical member 45 is pushed by the balls 35 to move along the ball groove A. The helical member 45 is rotated counterclockwise about the central axis m along the ball groove A and is displaced toward the second axial side.

In the ball screw device 31, the diameter of each of the balls 35 is smaller than the average diameter of the ball groove A, and the movement amount S of the ball row P along the second helical groove 41 due to rotation of the screw shaft 32 is approximately half the movement amount of a point on the first helical groove 39 along the first helical groove 39 due to rotation of the screw shaft 32. That is, when the screw shaft 32 is rotated counterclockwise about the central axis m by an angle of ϕ, the ball row P is displaced to a position at which the ball row P is located after the ball row P is rotated counterclockwise about the central axis m by an angle of ϕ/2. The helical member 45 is moved in the ball groove A while being in contact with the ball row P. The rotation angle of the helical member 45 about the central axis m is therefore equal to the rotation angle (ϕ)/2) of the ball row P about the central axis m.

The axial movement amounts of the nut 33 and the ball row P are proportional to the rotation angle about the central axis m. That is, when D represents the movement amount of the nut 33 toward the first axial side when the screw shaft 32 is rotated counterclockwise about the central axis m by the angle of ϕ, the axial movement amount d of the ball row P with respect to the nut 33 is one half (½) of the movement amount D of the nut 33, but this axial movement amount d of the ball row P is the movement amount toward the second axial side, which is opposite to the first axial side toward which the nut 33 is moved. Similarly, the movement amount of the helical member 45 toward the second axial side with respect to the nut 33 is ½ of the movement amount D of the nut 33.

When the screw shaft 32 is rotated counterclockwise by the angle of ϕ, the helical member 45 is displaced to a position at which the helical member 45 is located after the helical member 45 is rotated counterclockwise by the angle of ϕ/2 from its initial position, and the amount by which the helical member 45 protrudes beyond the end face 33a of the nut 33, which is located on the second axial side, is increased by D/2 from that in the initial position. The end of the helical member 45, which is located on the second axial side, is locked (stopped) by the protrusion 58 of the coupling member 55. Accordingly, the coupling member 55 is rotated counterclockwise in the spring accommodating portion 53 and is displaced toward the second axial side with respect to the nut 33. As shown in the upper portion (a) in FIG. 6, L represents the axial dimension (axial length) between the end face 33a, which is located on the second axial side, in the outer groove formation portion 44 of the nut 33 and the seating surface 56 of the coupling member 55 in the initial position. When the screw shaft 32 is rotated and the nut 33 is moved toward the first axial side by D, the axial dimension between the end face 33a of the nut 33, which is located on the second axial side, and the seating surface 56 of the coupling member 55 is L+D/2, as shown in the lower portion (b) in FIG. 6.

The end of the helical torsion spring 37, which is located on the first axial side, is engaged with the protrusion 59 of the coupling member 55. The end of the helical torsion spring 37, which is located on the second axial side, is engaged with the protrusion 60 of the spring end fixing member 62 and is fixed in the circumferential direction. In the first embodiment, the helical torsion spring 37 is right-hand wound. Accordingly, when the coupling member 55 is rotated counterclockwise about the central axis m, the end of the helical torsion spring 37, which is located on the first axial side, is rotated in such a direction that its coil is untwisted. The helical torsion spring 37 is thus elastically deformed and its average coil diameter is increased. In the first embodiment, the helical torsion spring 37 is fitted in the spring accommodating portion 53 with a large radial clearance between the helical torsion spring 37 and the inner periphery of the spring accommodating portion 53. Accordingly, even when the rotation angle of the screw shaft 32 is large, the outer periphery of the helical torsion spring 37 does not contact the inner periphery of the spring accommodating portion 53, and the helical torsion spring 37 can be smoothly deformed within its elastic range. Smooth movement of the helical member 45 therefore is not hindered. The helical torsion spring 37 is wound such that coils (windings, i.e., turns of a wire) are arranged at predetermined intervals in the axial direction. The helical torsion spring 37 is therefore compressed in the axial direction when the coupling member 55 is moved toward the second axial side. However, since the coils (windings) of the helical torsion spring 37 do not closely contact each other, the helical torsion spring 37 can be smoothly deformed within its elastic range. Smooth movement of the helical member 45 therefore is not hindered.

Thereafter, the screw shaft 32 is rotated clockwise, and the brake pad 12 is displaced in the direction away from the brake rotor 11. The ball screw device 31 thus returns to the state shown in the upper portion (a) in FIG. 6, and application of the braking force to the wheel is stopped. At this time, the ball row P is moved clockwise along the ball groove A due to the rotation of the screw shaft 32. At the same time, the helical torsion spring 37 is restored to its original shape. The helical member 45 is therefore moved clockwise together with the ball row P.

As described above, in the ball screw device 31 of the first embodiment, the helical member 45 can be smoothly moved when the screw shaft 32 is rotated. Smooth movement of the ball row P therefore is not hindered. Accordingly, the nut 33 can be smoothly moved in a large range in the axial direction.

In the case where there is no slipping between the balls 35 and each helical groove 39, 41, the ball row P is returned to its initial position when the screw shaft 32 is returned to its original position (position at the angle ϕ=0). However, slipping may occur between the balls 35 and each helical groove 39, 41 due to a change in contact state of the balls 35 with each helical groove 39, 41, etc. (the state of contact between the balls 35 and each helical groove 35, 41, etc.). In this case, one or more of the balls 35 may be delayed in moving, that is, the movement amount of the ball 35 may vary among the balls 35. In the first embodiment, however, the helical member 45 is biased (urged) toward the first axial side by the helical torsion spring 37. Accordingly, when the external force F is no longer applied, all of the balls 35 can be displaced toward the first axial side, and thus, the ball row P is returned to its initial position. The ball screw device 31 of the first embodiment can thus prevent displacement of the initial position of the ball row P. The balls 35 can therefore reliably roll when the ball screw device 31 is operated again.

As described above, in the ball screw device 31, the nut 33 can move in an increased range in the axial direction, and the ball row P can be returned to its initial position when operation of the ball screw device 31 is finished. Movement of the ball row P therefore is not inhibited, and the nut 33 can be smoothly moved in a large range in the axial direction.

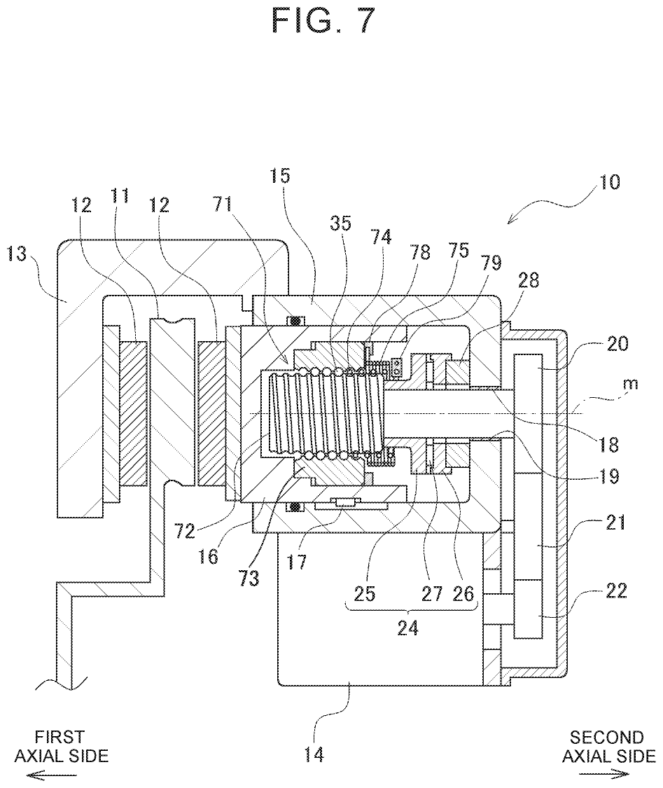

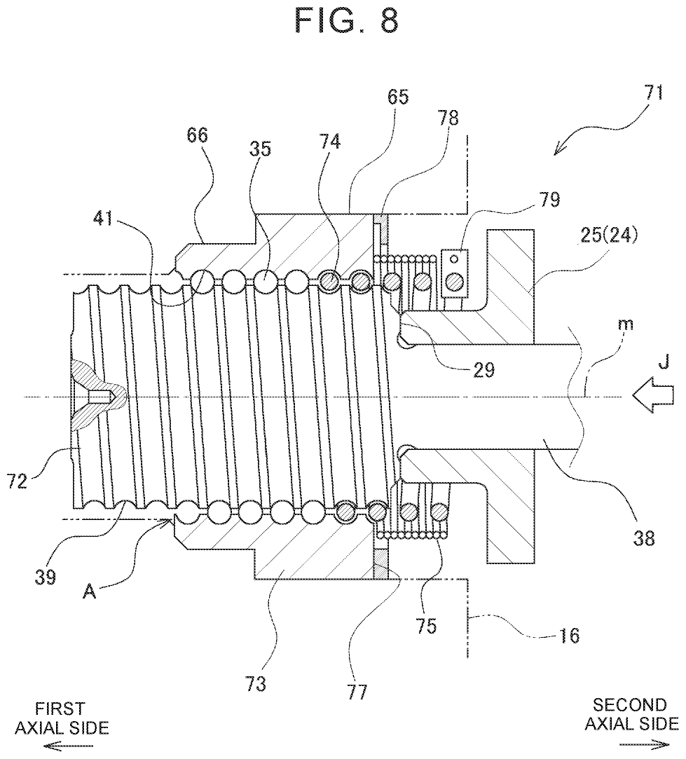

A second embodiment of the disclosure will be described. FIG. 7 is a sectional view in the axial direction showing a schematic structure of a brake device 10 including a ball screw device 71 of the second embodiment. FIG. 8 is an enlarged view of a part of the ball screw device 71 of FIG. 7. As in the first embodiment, the ball screw device 71 is mounted in a piston 16. The ball screw device 71 is different from the ball screw device 31 of the first embodiment in form and arrangement of the helical member and the helical torsion spring. The axial length of the ball screw device 71 can thus be reduced as compared to the ball screw device 31 of the first embodiment. In the following description, the configurations different from those of the first embodiment will be described in detail, and the same configurations as those of the first embodiment will be denoted with the same reference characters and will be only briefly described or description thereof will be omitted.

Referring to FIG. 8, the ball screw device 71 includes a screw shaft 72, a nut 73, a plurality of balls 35, a helical member 74, and a helical torsion spring 75 (first biasing member).

The screw shaft 72 is in a form similar to that of the screw shaft 32 of the first embodiment and has a first helical groove 39 formed on the outer periphery thereof. The first helical groove 39 is similar to that of the first embodiment. As in the first embodiment, the screw shaft 72 has a step side surface 29 extending in a direction perpendicular to the central axis m, and the screw shaft 72 is fixed in the axial direction with respect to a cylinder 15 via a thrust bearing 24 contacting the step side surface 29 and an axial force measuring device 28 (see FIG. 7).

Unlike the nut 33 of the first embodiment, the nut 73 does not have a spring accommodating portion. That is, the axial dimension (axial length) of the nut 73 is similar to the axial length of the outer groove formation portion 44 of the first embodiment, and an end face 77 of the nut 73, which is located on the second axial side, is formed at the same axial position as that of the end face 33a of the first embodiment, and the end face 77 extends in the direction perpendicular to the central axis m. An outer peripheral portion of the nut 73 has a stepped, substantially cylindrical shape. An outer peripheral surface 65 of the nut 73, which is located on the second axial side, is a cylindrical surface coaxial with the central axis m, and an outer peripheral surface 66 of the nut 73, which is located on the first axial side, is a polygonal surface (e.g., a regular hexagonal surface, or a regular octagonal surface) in a section taken along the direction perpendicular to the central axis m. A second helical groove 41, which is similar to that of the nut 33 of the first embodiment, is formed to have a helical shape on the inner periphery of the nut 73 along the entire length (entire area) of the nut 73 in the axial direction. The nut 73 is fitted on (in other words, fitted to) the outer periphery of the screw shaft 72, and the first helical groove 39 and the second helical groove 41 face each other in the radial direction to form a helical ball groove A. As in the first embodiment, the plurality of balls 35 are arranged in the ball groove A and separating springs 42 are inserted at predetermined intervals among the balls 35 (see FIG. 3). The nut 73 has a stopper portion 47 provided on the first axial side of the ball row P, and a first-side coil spring 36 (second biasing member) is disposed on the first axial side of the ball row P (see FIG. 4).

Next, the helical member 74 and the helical torsion spring 75 will be described. The helical member 74 is made of a steel material such as a wire for springs, fiber-reinforced plastic (FRP), or the like, and is formed to have a helical shape that is the same or similar to that of the ball groove A. The helical member 74 is disposed on the second axial side relative to the ball row P (i.e., the helical member 74 is disposed closer to the second axial side than the ball row P is) in the ball groove A. The diameter (thickness) of a line (for example, a wire) of the helical member 74 is smaller than the inside diameter of the ball groove A. Since there is a clearance between the helical member 74 and the ball groove A, the helical member 74 moves along the ball groove A so as to rotate about the central axis m. The helical member 74 can thus move along the ball groove A. As described below, the end of the helical member 74, which is located on the second axial side, is coupled to the end of the helical torsion spring 75, which is located on the second axial side. The helical member 74 therefore has a larger number of turns than that of the helical member 45 of the first embodiment.

The helical torsion spring 75 is disposed radially outward of the helical member 74 so as to be located coaxially with the helical member 74. The helical torsion spring 75 is produced by winding a wire for springs such as a piano wire into a helix. Unlike in the first embodiment, the helical torsion spring 75 is left-hand wound. The coils (windings, i.e., turns of a wire) of the helical torsion spring 75 are in close contact with each other in the axial direction, namely the helical torsion spring 75 is in the form of what is called a “tightly wound spring,” when the helical torsion spring 75 is in a free state, namely when no external force is being applied to the helical torsion spring 75. The inside diameter of the helical torsion spring 75 (the diameter of the inner periphery of its coil portion) is larger than the outside diameter of the helical member 74 (the diameter of the outer periphery of its coil portion). The helical torsion spring 75 is disposed with a small radial clearance being provided between the helical torsion spring 75 and the outer periphery of the helical member 74 and a large radial clearance being provided between the helical torsion spring 75 and the inner periphery of the piston 16. The end (the other end, i.e., a second end) of the helical torsion spring 75, which is located on the first axial side, is fixed with respect to the nut 73 by a spring end fixing member 78. The end (one end, in other words, a first end) of the helical torsion spring 75, which is located on the second axial side, is coupled to the end of the helical member 74, which is located on the second axial side, by a coupling member 79.

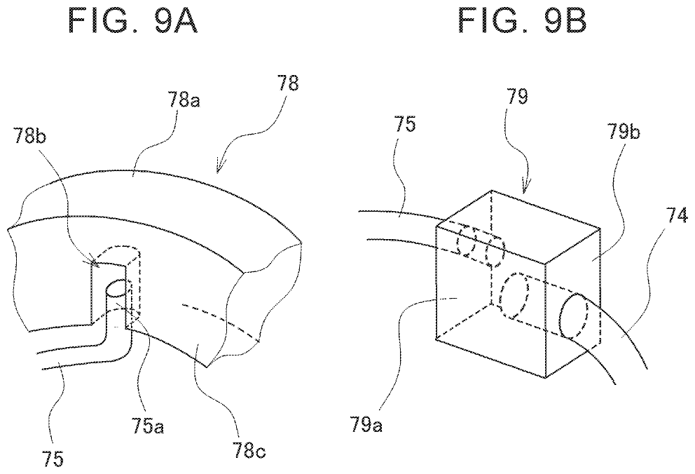

FIGS. 9A and 9B are perspective views showing an example of the form of the spring end fixing member 78 and the coupling member 79. FIG. 9A schematically shows a state where the end of the helical torsion spring 75, which is located on the first axial side, is fixed by the spring end fixing member 78. FIG. 9B schematically shows a state where the end of the helical torsion spring 75, which is located on the second axial side, is coupled to the end of the helical member 74, which is located on the second axial side, by the coupling member 79.

As shown in FIG. 9A, the end of the helical torsion spring 75, which is located on the first axial side, is bent radially outward from the coil portion at a substantially right angle to form a spring locking portion 75a. The spring end fixing member 78 has an annular shape, and FIG. 9A shows in enlarged scale a part of the spring end fixing member 78 in the circumferential direction, namely a part that holds the spring end of the helical torsion spring 75. The spring end fixing member 78 is made of a synthetic resin such as polyamide resin or a metal such as carbon steel. An outer peripheral surface 78a of the spring end fixing member 78 is a cylindrical surface coaxial with the central axis m. The diameter of the outer peripheral surface 78a is slightly larger than the diameter of the inner peripheral surface (the surface to which the spring end fixing member 78 is fitted) of the piston 16. The diameter of the inner peripheral surface of the spring end fixing member 78 is larger than the outside diameter of the helical torsion spring 75. The spring end fixing member 78 has a spring end accommodating portion 78b provided in its side surface 78c located on the first axial side. The spring end accommodating portion 78b accommodates the spring locking portion 75a. The spring end accommodating portion 78b has a predetermined depth in the axial direction and extends radially outward from the inner peripheral surface of the spring end fixing member 78. The spring end fixing member 78 accommodating the spring locking portion 75a in the spring end accommodating portion 78b is press-fitted in the piston 16 such that the side surface 78c contacts the end face 77 of the nut 73. Thus, the end of the helical torsion spring 75, which is located on the first axial side, is fixed with respect to the nut 73 so as not to be displaceable in the circumferential and axial directions.

As shown in FIG. 9B, the end of the helical torsion spring 75, which is located on the second axial side, is coupled to the end of the helical member 74, which is located on the second axial side, by the coupling member 79. The coupling member 79 is in the shape of a substantially rectangular parallelepiped and is made of synthetic resin, carbon steel, or the like. The coupling member 79 has a pair of surfaces 79a, 79b that face each other in the circumferential direction when the coupling member 79 is disposed in the ball screw device 71. The coupling member 79 has holes that are provided in the surfaces 79a, 79b, respectively. The end of the helical torsion spring 75, which is located on the second axial side, and the end of the helical member 74, which is located on the second axial side, are inserted in the holes of the surfaces 79a, 79b, respectively. Each of the end of the helical torsion spring 75, which is located on the second axial side, and the end of the helical member 74, which is located on the second axial side, extends straight in a direction tangential to the coil portion and is fixedly inserted in the hole. The end of the helical torsion spring 75, which is located on the second axial side, and the end of the helical member 74, which is located on the second axial side are thus coupled to each other.

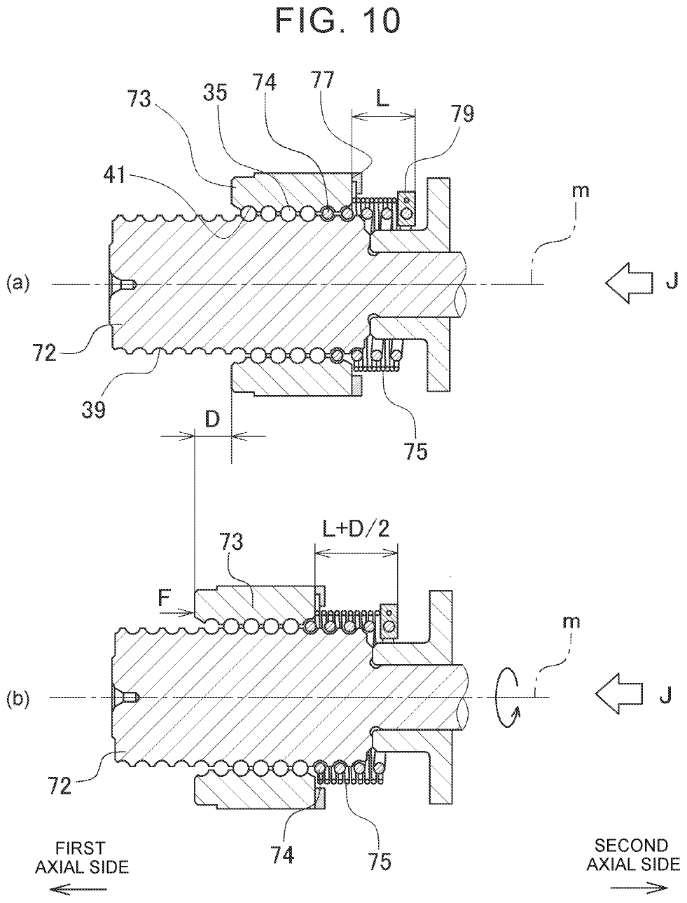

Operation of each part at the time when the ball screw device 71 is operated and functions and effects of the ball screw device 71 will be described with reference to FIG. 10. An upper portion (a) in FIG. 10 shows the positions of the helical member 74, the helical torsion spring 75, etc. with respect to the screw shaft 72 under no load condition before the ball screw device 71 is operated. A lower portion (b) in FIG. 10 shows the positions of the helical member 74, the helical torsion spring 75, etc. with respect to the screw shaft 72 at the time when the screw shaft 72 is rotated and the nut 73 is pushed toward the first axial side. Each of the upper portion (a) and the lower portion (b) of FIG. 10 shows the ball screw device 71 in the same orientation as in FIG. 7. The piston 16, the brake pads 12, etc. are not shown in FIG. 10. In the following description, the direction in which the screw shaft 72 and the ball row P rotate or move about the central axis m is the direction as viewed in the direction of arrow J in FIG. 10.

As shown in the upper portion (a) in FIG. 10, before the ball screw device 71 is operated, the coils (windings) of the helical torsion spring 75 are in close contact with each other in the axial direction.

As shown in the lower portion (b) in FIG. 10, the ball screw device 71 is then operated. In the second embodiment, the first helical groove 39 is a right-handed helical groove. When the screw shaft 72 is rotated counterclockwise, the nut 73 is displaced toward the first axial side, and the piston 16 is pushed toward the brake rotor 11. As the brake pads 12 are pressed against the brake rotor 11, the reaction force is applied to the nut 73 in the axial direction as an external force F, and the balls 35 are strongly pressed against the first helical groove 39 and the second helical groove 41. The balls 35 thus roll in the first helical groove 39 and the second helical groove 41 with rotation of the screw shaft 72. Since the screw shaft 72 is rotated counterclockwise, the balls 35 roll counterclockwise and move in the second helical groove 41 toward the second axial side. At this time, the helical member 74 is pushed by the balls 35 to move along the ball groove A. The helical member 74 is rotated counterclockwise about the central axis m along the ball groove A and is displaced toward the second axial side with respect to the nut 73.

In the ball screw device 71, the diameter of each of the balls 35 is smaller than the average diameter of the ball groove A that extends about the central axis m. Accordingly, the movement amount S of the ball row P along the second helical groove 41 due to rotation of the screw shaft 72 is approximately half the movement amount of a point on the first helical groove 39 along the first helical groove 39 around the central axis m due to rotation of the screw shaft 72. That is, when the screw shaft 72 is rotated counterclockwise about the central axis m by an angle of ϕ, the ball row P is displaced to a position at which the ball row P is located after the ball row P is rotated counterclockwise about the central axis m by an angle of ϕ/2. The helical member 74 is moved in the ball groove A while being in contact with the ball row P. The rotation angle of the helical member 74 about the central axis m is therefore equal to the rotation angle ϕ/2) of the ball row P about the central axis m.

The axial movement amounts of the nut 73 and the ball row P are proportional to the rotation angle about the central axis m. That is, when D represents the movement amount of the nut 73 toward the first axial side when the screw shaft 72 is rotated counterclockwise about the central axis m by the angle of ϕ, the axial movement amount d of the ball row P with respect to the nut 73 is ½ of the movement amount D of the nut 73, but this axial movement amount d of the ball row P is the movement amount toward the second axial side, which is opposite to the first axial side toward which the nut 73 is moved. Similarly, the movement amount of the helical member 74 toward the second axial side with respect to the nut 73 is ½ of the movement amount D of the nut 73.

When the screw shaft 72 is rotated counterclockwise by the angle of ϕ at the time when the ball screw device 71 is operated to push the piston 16 toward the brake rotor 11, the nut 73 is moved toward the first axial side by D, the helical member 74 is displaced to a position at which the helical member 74 is located after the helical member 74 is rotated counterclockwise by the angle of ϕ/2 from its initial position, and the amount by which the helical member 74 protrudes beyond the end face 77 of the nut 73, which is located on the second axial side, is increased by D/2 from that in the initial position. Specifically, as shown in the upper portion (a) in FIG. 10, L represents the axial dimension (axial length) between the end face 77 of the nut 73, which is located on the second axial side, and the surface of the coupling member 79, which is located on the second axial side, in the initial position. For example, when the screw shaft 72 is rotated and the nut 73 is moved toward the first axial side by D, the axial dimension (axial length) between the end face 77 of the nut 73, which is located on the second axial side, and the surface of the coupling member 79, which is located on the second axial side, is L+D/2, as shown in the lower portion (b) in FIG. 10.

The end of the helical member 74, which is located on the second axial side, is coupled to the end of the helical torsion spring 75, which is located on the second axial side, by the coupling member 79. Accordingly, when the screw shaft 72 is rotated counterclockwise by the angle of ϕ, the end of the helical torsion spring 75, which is located on the second axial side, is rotated counterclockwise by the angle of ϕ/2 and is displaced toward the second axial side with respect to the nut 73 by D/2.

The end of the helical torsion spring 75, which is located on the first axial side, is fixed with respect to the nut 73 by the spring end fixing member 78 so as not to be displaceable in the circumferential and axial directions. Accordingly, when the screw shaft 72 is rotated, the ends of the helical torsion spring 75, which are respectively located on the first and second axial sides, are displaced in the direction away from each other, and thus, a space is formed between adjacent coils (windings) of the helical torsion spring 75 in the axial direction.

In the second embodiment, the helical torsion spring 75 is left-hand wound. Accordingly, when the end of the helical torsion spring 75, which is located on the second axial side, is rotated counterclockwise about the central axis m, the end of the helical torsion spring 75, which is located on the second axial side, is displaced in such a direction that its coil is untwisted. The average coil diameter of the helical torsion spring 75 is therefore increased. In the second embodiment, the helical torsion spring 75 is disposed in the piston 16 with a large radial clearance between the helical torsion spring 75 and the inner periphery of the piston 16. Accordingly, even when the outside diameter of the helical torsion spring 75 is increased with an increase in rotation angle of the screw shaft 72, the outer periphery of the helical torsion spring 75 does not contact the inner periphery of the piston 16.

As described above, when the screw shaft 72 is rotated, the helical torsion spring 75 can be smoothly deformed within its elastic range. Accordingly, when the ball screw device 71 is operated and the piston 16 is pushed toward the brake rotor 11, the helical member 74 is always pushed toward the ball row P.

Thereafter, in order to stop application of the braking force to the wheel, the screw shaft 72 is rotated clockwise and the brake pad 12 is displaced in the direction away from the brake rotor 11. At this time, the ball row P is moved clockwise with respect to the nut 73 along the ball groove A due to rotation of the screw shaft 72. Since the helical member 74 is being biased (urged) toward the ball row P by the helical torsion spring 75, the helical member 74 is moved with the ball row P and the end of the helical member 74, which is located on the second axial side, is rotated clockwise about the central axis m. The elastic deformation of the helical torsion spring 75 thus decreases gradually. At the same time, the amount by which the helical member 74 protrudes beyond the end face 77 of the nut 73, which is located on the second axial side, decreases gradually, and the coils (windings) of the helical torsion spring 75 closely contact each other in the axial direction again. The ball screw device 71 thus returns to the state shown in the upper portion (a) in FIG. 10, and application of the braking force to the wheel is stopped.

As described above, in the ball screw device 71 of the second embodiment as well, the helical torsion spring 75 is smoothly elastically deformed when the screw shaft 72 is rotated. The helical member 74 can therefore be smoothly moved. Accordingly, the ball row P can be smoothly moved and the nut 73 can be smoothly moved in a large range in the axial direction. Moreover, in the second embodiment, the helical torsion spring 75 is pulled in the axial direction when the ball screw device 71 is operated. Accordingly, the coils of the helical torsion spring 75 can be in close contact with each other in the initial state. Therefore, the axial length of the helical torsion spring 75 can be reduced, and accordingly, the axial length of the ball screw device 71 can be reduced.

The helical member 74 is constantly biased (urged) toward the first axial side by the helical torsion spring 75. Accordingly, even when one or more of the balls 35 are delayed in moving, that is, the movement amount of the ball 35 varies among the balls 35, all of the balls 35 can be displaced toward their initial positions when the external force F is no longer applied. The ball row P is thus returned to its initial position when the axial load of the ball screw device 71 is removed. At this time, in the ball row P, the force of the first-side coil spring 36 biasing the ball row P in the axial direction, the force of the helical torsion spring 37 biasing the ball row P toward the first axial side, and the force of each separating spring 42 biasing the balls 35 respectively provided on its both sides along the ball groove A are substantially balanced. The ball screw device 71 of the second embodiment can thus prevent displacement of the initial position of the ball row P. The balls 35 can therefore reliably roll when the ball screw device 71 is operated again.

As described above, in the ball screw device according to the disclosure, the nut 73 is movable in an increased range in the axial direction, and the ball row P can be returned to its initial position when operation of the ball screw device is finished. Accordingly, movement of the ball row P along the ball groove A is not hindered, and the nut 73 can be smoothly moved in a large range in the axial direction.

Although the embodiments of the disclosure are described above, these embodiments are shown by way of illustration. The disclosure is not limited to these embodiments, and these embodiments can be modified as appropriate without departing from the scope of the disclosure.

For example, although the helical torsion spring 37 is right-hand wound in the first embodiment, the helical torsion spring 37 may be left-hand wound. In this case, the average coil diameter of the helical torsion spring 37 is decreased when the coupling member 55 is rotated counterclockwise about the central axis m. The outside diameter of the helical torsion spring 37 therefore may be slightly smaller than the inside diameter of the spring accommodating portion 53. Thus, there is a large radial clearance between the inner periphery of the helical torsion spring 37 and the outer periphery of the screw shaft 32. Accordingly, even when the rotation angle of the screw shaft 32 is large, the inner periphery of the helical torsion spring 37 does not contact the outer periphery of the screw shaft 32 and the helical torsion spring 37 can be smoothly deformed within its elastic range. Similarly, in the second embodiment, the helical torsion spring 75 may be right-hand wound. In this case, the outside diameter of the helical torsion spring 75 may be made slightly smaller than the inside diameter of the piston 16 so that the radial clearance between the helical torsion spring 75 and the outer periphery of the helical member 74 is increased.

In the first embodiment, the nut 33 has the spring accommodating portion 53, and the spring end fixing member 62 is fixed to the inner periphery of the spring accommodating portion 53 by press fit. However, as in the second embodiment, the nut 33 may not have the spring accommodating portion 53 and the spring end fixing member 62 may be fixed to the inner periphery of the piston 16 by press fit. In the second embodiment, the spring end fixing member 78 may be directly fixed to the nut 73.

In the above embodiments, the first helical groove 39 is a right-handed helical groove. However, the first helical groove 39 may be a left-handed helical groove.

In this case, the brake pads 12 are pressed against the brake rotor 11 when the screw shaft 32 or 72 is rotated clockwise. Accordingly, each of the helical members 45, 74 is also a left-handed helical member. Since movement of each part is similar to that in the above embodiments, detailed description thereof will be omitted. The form of each of the coupling members 55, 79 of the above embodiments is shown by way of illustration, and the coupling members 55, 79 may be in various forms, as long as the coupling members 55, 79 are able to transmit movement of the helical members 45, 74 to the helical torsion springs 37, 75, respectively. The helical member 45 may be directly engaged with the helical torsion spring 37, with no coupling member therebetween. The helical member 74 may be directly engaged with the helical torsion spring 75, with no coupling member therebetween. In the above embodiments, the ball screw device is used for the brake device. However, the ball screw device is also applicable to other devices.

What is claimed is:

1. A ball screw device comprising:
a screw shaft having a first helical groove provided on an outer periphery of the screw shaft;
a nut having a second helical groove provided on an inner periphery of the nut, the nut being fitted on the outer periphery of the screw shaft;
a plurality of balls that are disposed in a ball groove such that the plurality of balls are rollable, the ball groove being provided between the first helical groove and the second helical groove that are disposed so as to face each other in a radial direction;
a helical member that extends in a helical shape along the ball groove and is displaceable along the ball groove; and
a first biasing member that biases the helical member toward the plurality of balls.

2. The ball screw device according to claim 1, further comprising
a second biasing member that is disposed on an opposite side of the plurality of balls from the helical member, and biases the plurality of balls toward the helical member.

3. The ball screw device according to claim 1, wherein:
when the screw shaft is rotated about an axis of the screw shaft in a circumferential direction, the nut is displaced toward a first axial side in an axial direction against an external force, the axial direction being a direction of the axis of the screw shaft, and the circumferential direction being a direction extending around the axis of the screw shaft;
the helical member is disposed closer to a second axial side in the axial direction than the plurality of balls are; and
the first biasing member is a helical torsion spring having a first end and a second end, the first end of the first biasing member is directly or indirectly engaged with an end of the helical member, the end of the helical member being located on the second axial side, and the second end of the first biasing member is fixed with respect to the nut.
